(19) United States
(12) Patent Application Publication
(10) Pub. No.: US 2022/0229539 A1
(43) Pub. Date: Jul. 21, 2022

(54) METHOD FOR LAUNCHING APPLICATION ON TERMINAL DEVICE, AND TERMINAL DEVICE

(71) Applicant: GUANGDONG OPPO MOBILE TELECOMMUNICATIONS CORP., LTD., Dongguan (CN)

(72) Inventors: Yi JIANG, Dongguan (CN); Yan CHEN, Dongguan (CN)

(21) Appl. No.: 17/714,761

(22) Filed: Apr. 6, 2022

Related U.S. Application Data
(63) Continuation of application No. PCT/CN2020/118096, filed on Sep. 27, 2020.

(30) Foreign Application Priority Data
Oct. 8, 2019 (CN) 201910948019.1

(51) Int. Cl. G06F 3/04817; H04M 1/72403; G06F 3/04847; G06F 9/445; G06F 1/3234

(52) U.S. Cl. CPC G06F 3/04817; H04M 1/72403; G06F 1/3265; G06F 9/445; G06F 3/04847

(57) ABSTRACT

A method for launching an application on a terminal device, and a terminal device, relating to the technical field of computers. According to embodiments of the disclosure, at least one application icon is displayed on a screen-off display interface of the terminal device, where the screen-off display interface is a user interface displayed on the terminal device in a screen-off display mode. In response to receiving a preset touch signal, the terminal device launches an application corresponding to one application icon of the at least one application icon, where the preset touch signal is triggered by the terminal device upon receiving a preset touch operation performed on the one application icon.

This application is a continuation of International Application No. PCT/CN2020/118096, filed Sep. 27, 2020, which claims priority to Chinese Patent Application No. 201910948019.1, filed Oct. 8, 2019, the entire disclosures of which are incorporated herein by reference.

### TECHNICAL FIELD

The disclosure relates to a technical field of computer technologies, and particularly to a method for launching an application on a terminal device and a terminal device.

### BACKGROUND

As the mobile terminals are applied widespread in daily life, the mobile terminal provides a large visual range and a good display effect by using a large-size touch screen. However, a high power consumption of the large-size touch screen seriously challenges the battery life of the mobile terminal.

In the related art, in response to detecting the mobile terminal is locked, the mobile terminal enters a screen-off display mode to save the power consumption. When a target application requires to be launched on the mobile terminal, the mobile terminal device switches on the touch screen and performs an identity authentication operation. After the user is successfully authenticated by the mobile terminal, the terminal device is unlocked and displays the home screen, and then the user can click an application icon displayed on the home screen to launch an application corresponding to the clicked application icon.

### SUMMARY

Embodiments of the disclosure provide a method for launching an application on a terminal device, and a terminal device. The technical solutions are described as follows.

According to an aspect of the disclosure, a method for launching an application on a terminal device is provided. The method includes operations as follows. At least one application icon is displayed on a screen-off display interface of the terminal device, where the screen-off display interface is a user interface displayed on the terminal device in a screen-off display mode. An application corresponding to one application icon of the at least one application icon is launched, in response to receiving a preset touch signal, where the preset touch signal is triggered by the terminal device upon receiving a preset touch operation performed on the one application icon.

According to another aspect of the disclosure, another method for launching an application on a terminal device is provided. The terminal device includes an application processor and a coprocessor, and a power consumption of the coprocessor is less than a power consumption of the application processor. The method includes the operations as follows. The application processor enters a sleep state, in response to detecting that the terminal device is in a screen-off display mode. The coprocessor controls at least one application icon to be displayed on a screen-off display interface of the terminal device, where the at least one application icon includes at least one of a quick application icon and an unlock application icon. In response to receiving a preset touch signal, the coprocessor controls an application corresponding to one application icon of the at least one application icon to be launched. The preset touch signal is triggered by the terminal device upon receiving a preset touch operation performed on the one application icon.

According to yet another aspect of the disclosure, a terminal device is provided. The terminal device includes an application processor and a coprocessor, and a power consumption of the coprocessor is less than a power consumption of the application processor. The application processor is configured to enter a sleep state, in response to detecting that the terminal device is in a screen-off display mode. The coprocessor is configured to control at least one application icon to be displayed on a screen-off display interface of the terminal device, where the at least one application icon includes at least one of a quick application icon and an unlock application icon. The coprocessor is configured to receive a preset touch signal, and in response to receiving the preset touch signal, launch an application corresponding to one application icon of the at least one application icon. The preset touch signal is triggered by the terminal device upon receiving a preset touch operation performed on the one application icon.

### BRIEF DESCRIPTION OF THE DRAWINGS

In order to more clearly illustrate technical solutions in the embodiments of the disclosure, drawings used in the description of the embodiments will be briefly described below. Obviously, the drawings in the following description are merely some embodiments of the disclosure. For those skilled in the art, other drawings may also be obtained based on these drawings without paying any creative work.

FIG. 1 illustrates a structural block diagram of a terminal device provided by some exemplary embodiments of the disclosure.

FIG. 2 is a flowchart illustrating a method for launching an application on a terminal device provided by some exemplary embodiments of the disclosure.

FIG. 3 is a schematic diagram illustrating unlocking of a terminal device based on the embodiment illustrated in FIG. 2.

FIG. 4 is a flowchart illustrating another method for launching an application on a terminal device provided by some exemplary embodiments of the disclosure.

FIG. 5 is a flowchart illustrating yet another method for launching an application on a terminal device provided by some exemplary embodiments of the disclosure.

FIG. 6 is a flowchart illustrating still another method for launching an application on a terminal device provided by some exemplary embodiments of the disclosure.

FIG. 7 is a schematic diagram illustrating an interface on which the terminal device displays n application icons provided by the embodiments illustrated in FIG. 6.

FIG. 8 is a schematic diagram illustrating another interface on which the terminal device displays n application icons provided by the embodiments illustrated in FIG. 6.

FIG. 9 is a schematic diagram illustrating an appearance of the terminal device provided by the embodiments illustrated in FIG. 6.

FIG. 10 is a schematic diagram illustrating displaying of the application icons on the terminal device based on the embodiments illustrated in FIG. 6.

FIG. 11 is another schematic diagram illustrating displaying of the application icons on the terminal device based on the embodiments illustrated in FIG. 6.

FIG. 12 illustrates a structural block diagram of an apparatus for launching an application on a terminal device provided by some exemplary embodiments of the disclosure.

FIG. 13 illustrates a structural block diagram of another apparatus for launching an application on a terminal device provided by some exemplary embodiments of the disclosure.

### DETAILED DESCRIPTION

In order to more clearly illustrate objects, technology solutions and advantages of the disclosure, the embodiments of the disclosure will be further described in detail below in conjunction with the drawings.

When the following description involves the drawings, unless otherwise indicated, the same numerals in different drawings represent the same or similar elements. The implementations described in the following exemplary embodiments do not represent all implementations that are consistent with the disclosure. On the contrary, the implementations are merely examples of apparatuses and methods that are described in detail in the appended claims and that are consistent with some aspects of the disclosure.

In the description of the disclosure, it should be noted that terms “first”, “second” and the like, are only used for the purpose of description and cannot be understood as indicating or implying relative importance. In the description of the disclosure, it should be noted that, unless otherwise clearly specified and limited, the terms “interconnect” and “connect” should be understood broadly. For example, it may mean a fixed connection, a removable connection, or an all-in-one connection; a mechanical connection, or an electrical connection; a direct connection, or an indirect connection through an intermediate medium. For those skilled in the art, the specific meaning of the above-mentioned terms in the disclosure can be understood under specific circumstances. In addition, in the description of the disclosure, unless otherwise specified, “multiple” means two or more. “And/or” describes an association relationship of associated objects, and indicates that there can be three types of relationships, for example, A and/or B may represent three situations: A exists alone, A and B exist at the same time, and B exists alone. The character “/” generally represents that the associated objects before and after it are in an “or” relationship.

The embodiments of the disclosure provide the technology solutions as follows.

The method for launching an application on a terminal device includes operations as follows. At least one application icon is displayed on a screen-off display interface of the terminal device, where the screen-off display interface is a user interface displayed on the terminal device in a screen-off display mode. An application corresponding to one application icon of the at least one application icon is launched, in response to receiving a preset touch signal, where the preset touch signal is triggered by the terminal device upon receiving a preset touch operation performed on the one application icon.

Optionally, the preset touch signal includes any one of the following touch signals: a sliding touch signal, a long-press touch signal and a concurrent multi-touch signal. The sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located. The long-press touch signal is triggered by the terminal device upon receiving a target long-press operation performed on the one application icon. The concurrent multi-touch signal is triggered by the terminal device upon simultaneously receiving at least two target touch operations, and positions where the at least two target touch operations are performed includes at least a third position and a fourth position. The third position is the preset position of the touch screen, and the fourth position is the position where the one application icon is located.

Optionally, the at least one application icon includes an unlock application icon. The launching an application corresponding to one application icon of the at least one application icon in response to receiving a preset touch signal includes operations as follows. The touch screen is unlocked and a home screen is displayed, in response to receiving a preset touch signal directed at the unlock application icon; or an unlock interface is displayed, in response to receiving a preset touch signal directed at the unlock application icon.

Optionally, the at least one application corresponding to the at least one application icon includes a fast application.

Optionally, the displaying at least one application icon on a screen-off display interface of the terminal device includes the operations as follows. A target position on the screen-off display interface where a continuous touch operation is performed is acquired, in response to detecting an external force acting on the terminal device in the screen-off display mode; and the at least one application icon is displayed on the screen-off display interface based on the target position.

Optionally, the terminal device includes a gravity sensor, the touch screen is in a shape of a rectangle or a rounded rectangle, the touch screen includes a first edge and a second edge. The displaying, based on the target position, the at least one application icon on the screen-off display interface includes the operations as follows. The number n of the at least one application icon is acquired, where n is a positive integer. A gravity force measured by the gravity sensor is acquired.

Based on a component of the gravity force on the touch screen, an edge intersecting with the component is determined as a target bottom edge. The n application icons surrounding the target position are displayed, with the target bottom edge taken as a bottom edge of the screen-off display interface and with the target position taken as a reference point, where a relative position of an i-th application icon of the n application icons to the target position is constant, where i is a positive integer not greater than n.

Optionally, the determining, based on a component of the gravity force on the touch screen, an edge intersecting with the component as a target bottom edge includes the operations as follows. The second edge or the first edge is determined as the target bottom edge, in response to detecting that the component of the gravity force on the touch screen is a zero vector; or the edge intersecting with the component of the gravity force is determined as the target bottom edge, in response to detecting that the component of the gravity force on the touch screen is a non-zero vector.

The disclosure provides another method for launching an application on a terminal device, where the terminal device includes an application processor and a coprocessor, a power consumption of the coprocessor is less than a power consumption of the application processor. The method includes operations as follows. The application processor is controlled to enter a sleep state, in response to detecting that the terminal device is in a screen-off display mode. The coprocessor controls at least one application icon to be displayed on a screen-off display interface of the terminal device, where the at least one application icon corresponds to at least one fast application. In response to receiving a preset touch signal, the coprocessor controls to an application corresponding to one application icon of the at least one application icon to be launched, where the preset touch signal is triggered by the terminal device upon receiving a preset touch operation performed on the one application icon.

Optionally, the preset touch signal includes any one of the following touch signals: a sliding touch signal, a long-press touch signal or a concurrent multi-touch signal. The sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located. The long-press touch signal is triggered by the terminal device upon receiving a target long-press operation performed on the one application icon. The concurrent multi-touch signal is triggered by the terminal device upon simultaneously receiving at least two target touch operations, and positions where the at least two target touch operations are performed includes at least a third position and a fourth position. The third position is the preset position of the touch screen, and the fourth position is the position where the one application icon is located.

Optionally, the displaying, under control of the coprocessor, at least one application icon on a screen-off display interface of the terminal device includes the operations as follows. The coprocessor acquires a target position on the screen-off display interface where a continuous touch operation is performed, in response to detecting an external force acting on the terminal device in the screen-off display mode. The coprocessor controls the at least one application icon to be displayed on the screen-off display interface based on the target position.

To improve the effect that the terminal device quickly responses to a request of launching a specified application received on the screen-off interface, in the embodiments of the disclosure, the terminal device is enabled to display at least one application icon on the screen-off display interface, where the screen-off display interface is a user interface displayed on the terminal device in a screen-off display mode. In response to receiving the preset touch signal, the application corresponding to one application icon of the at least one application icon is launched, where the preset touch signal is triggered by the terminal device upon receiving the preset touch operation performed on the one application icon. In this way, when the screen of the terminal device is off, the terminal device may display the at least one application icon on the screen-off display interface. Once one of the at least one application icon is triggered by the preset touch signal, the terminal device can directly launch the application corresponding to the one triggered application icon without performing the unlock process. As such, the terminal device is enabled to directly launch the specified application on the screen-off interface without unlocking the terminal device.

In order to facilitate the understanding of the solutions shown in the embodiments of the disclosure, various terms appearing in the embodiments of the disclosure are introduced below.

The screen-off display mode (which is also known as always on display, AOD) mode refers to a display mode in which the terminal device displays information on the display screen when the display screen is off. In a possible implementation, in the screen-off display mode, the terminal device can display information through light emitted by pixels with self-luminescent capability. The screen-off display mode is different from a screen-off mode and a normal display mode. In the screen-off display mode, the information is displayed through light emitted by a part of pixels of the terminal device, rather than all the pixels. In a screen-on display mode, i.e., the normal display mode of the unlocked terminal device, the information is displayed through light emitted by all the pixels of the terminal device. In such scenario, the terminal device has low power consumption and is enabled to display relevant information.

In a possible implementation provided by the disclosure, in the screen-off display mode, the terminal device may display a current system time, a calendar, a notification message, or a screen saver animation, and other contents.

In another possible implementation provided by the disclosure, in the screen-off display mode, the terminal device may display an application icon. The user interface displayed on the terminal device in the screen-off display mode may be referred to as the screen-off display interface.

With regard to the screen-off display interface, in a possible implementation, the background of the screen-off display interface is black or some other dark color that is presented when the touch screen is not illuminated by a light source, that is, when none of the pixels of the touch screen emit light. In an application scenario, the screen-off display interface of the terminal device means that at least one icon composed of white lines or colorful lines is displayed on a black background.

The application icon refers to an icon displayed on the touch screen. Optionally, in response to detecting that the application icon is triggered, the terminal device displays a user interface corresponding to the application icon. In a possible implementation, the user interface displayed upon the triggering of the respective application icon may be a main interface of the application corresponding to the application icon, or a specified user interface of the application corresponding to the application icon. In another possible implementation, in response to detecting that the application icon is triggered, the terminal device may directly activate a function or service corresponding to the application icon. For example, when the application icon corresponds to a flashlight application, the terminal device directly launches the flashlight application once the application icon is triggered.

Optionally, the application icon may correspond to an application that is installed through an installation package, or may correspond to an application without being installed, such as an applet, a quick application, a mini application, or a light application, which is not limited in the disclosure.

The fast application refers to a system gadget or a system application provided by the terminal device, from one perspective. For example, the fast application may be a flashlight application, a mirror application, a calculator application, a compass application, a clock application, a timer application, a screen saver animation application, or a mini game application. From another perspective, the fast application may be a simplified application. For example, the fast application may also be at least one of a simplified camera application, a simplified memo application, or a simplified voice recorder application. For example, the simplified camera application only provides functions of shooting photos or videos, but does not provide a function of viewing albums. When the user needs to view the albums, the terminal device provides the function of viewing the albums after successfully authenticating the user's identity. For another example, the simplified memo application only provides a function of creating a new memo, but does not provide a function of viewing historical memos or editing existing memos. For yet another example, the simplified audio recorder application only provides a function of recording new audio, but does not provide a function of listening to existing recordings.

Exemplarily, the embodiments of the disclosure provide a method for launching an application in a terminal device. The method may be implemented by a terminal device capable of displaying information when the screen is off. The terminal device may include a mobile phone, a tablet computer, a smart watch, a digital camera, a MP4 playback terminal device, a MP5 playback terminal device, a learning machine, a point reading machine, an e-book or an electronic dictionary, etc.

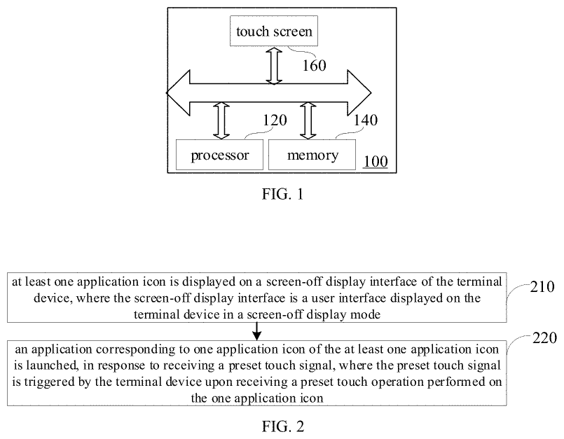

Referring to FIG. 1, a structural block diagram of a terminal device provided by some exemplary embodiments of the disclosure is illustrated. As illustrated in FIG. 1, the terminal device includes a processor 120, a memory 140, and a touch screen 160. The memory 140 stores thereon at least one instruction, and the at least one instruction is loaded and executed by the processor 120 to implement the method for launching an application on a terminal device provided by the various method embodiments of the disclosure.

In the disclosure, the terminal device 100 is capable of displaying information when the screen is off.

The processor 120 may include one or more processing core. The processor 120 uses various interfaces and lines to connect various parts of the entire terminal device 100. The processor 120 executes various functions of the terminal 100 and processes data by running or executing instructions, programs, code sets, or instruction sets stored in the memory 140 and calling data stored in the memory 140. Optionally, the processor 120 may be implemented as at least one hardware selected from digital signal processing (DSP), field-programmable gate array (FPGA), and programmable logic array (PLA). The processor 120 may be integrated with one of a central processing unit (CPU), a graphics processing unit (GPU), a modem, and the like, or a combination thereof. The CPU is mainly configured to process an operation system, a user interface, an application, etc. The GPU is configured to render and draw content required to be displayed on the touch screen. The modem is configured to process wireless communication. It can be understood that the modem may not be integrated into the processor 120, but may be implemented by a single chip.

In the embodiments of the disclosure, the processor 120 may include an application processor (AP) and a coprocessor. The power consumption per unit time of the coprocessor is less than the power consumption per unit time of the application processor. In the screen-off display mode, the coprocessor may perform the control tasks, and the application processor may enter a sleep state. Thus, it is possible to prevent the application processor from being frequently waked up in the screen-off display mode, and reduce the power consumption of the terminal device in the screen-off display mode while ensuring the normal operation of the terminal device in this mode.

The memory 140 may include a random access memory (RAM), and may also include a read-only memory (ROM). Optionally, the memory 140 includes a non-transitory computer-readable storage medium. The memory 140 may be used to store instructions, programs, codes, code sets or instruction sets. The memory 140 may include a program storage area and a data storage area, and the program storage area may store instructions for implementing an operation system, instructions for at least one function (such as a touch control function, a sound playback function, an image playback function), instructions for implementing the various method embodiments as follows, and the like; and the data storage area may store data involved in the various method embodiments.

The touch screen 160 may include a glass cover, a touch sensor, and a display component. The touch sensor may be integrated under the glass cover, and the glass cover is configured to protect the touch sensor and the display component. Optionally, the display component may include display pixels. In a possible display mode, the display pixels may be self-luminescent, which is not limited in the embodiments of the disclosure. The terminal device may display information only through self-luminescence of the display pixels.

Referring to FIG. 2, a flowchart illustrating a method for launching an application on a terminal device provided by some exemplary embodiments of the disclosure is illustrated. The method for launching an application on a terminal device may be implemented by the terminal device shown in FIG. 1. In FIG. 2, the method for launching an application on a terminal device includes blocks 210 and 220.

At block 210, at least one application icon is displayed on a screen-off display interface of the terminal device, where the screen-off display interface is a user interface displayed on the terminal device in a screen-off display mode.

In the embodiments of the disclosure, the display mode of the terminal device may include a screen-off display mode and a screen-on display mode, i.e., a normal display mode. In a possible implementation, after the terminal device is powered on, the touch screen of the terminal device may be in a display mode and a non-display mode. When the touch screen of the terminal device is in the display mode, a user interface is displayed in the touch screen of the terminal device displays. The displayed user interface may be a screen-off display interface in the screen-off display mode, or may be a normal display interface in the screen-on display mode.

In the embodiments of the disclosure, when the terminal device is in the screen-off display mode, the terminal device may display the at least one application icon on the screen-off display interface. The screen-off display interface refers to the user interface displayed on the terminal device in the screen-off display mode.

For example, in a possible display mode, the terminal device will enter the screen-off display mode, in response to detecting that no operation is performed on the terminal device within a long period of time or detecting that a press operation is performed on the power button. Optionally, whether to enable the screen-off display function of the terminal device performs may be set on a setting interface of the terminal device.

At block 220, an application corresponding to one application icon of the at least one application icon is launched, in response to receiving a preset touch signal, where the preset touch signal is triggered by the terminal device upon receiving a preset touch operation performed on the one application icon.

In the embodiments of the disclosure, in response to receiving the preset touch signal, the terminal device may launch the application corresponding to the one triggered application icon. The preset touch signal is triggered by the terminal device when the terminal device receives the preset touch operation performed on the one application icon of the displayed application icons.

It should be noted that, with regard to the preset touch signal received by the terminal device, one function thereof is to make the terminal device know that the terminal device is required to launch the application corresponding to the one application icon.

Regarding the application icons, the at least one application icon includes an icon of a fast application, for example, a flashlight application, a calculator application, or a compass application. The at least one application icon may also include an unlock application icon. The terminal device may unlock the touch screen and display a home screen, in response to detecting the received preset touch signal is directed at the unlock application icon. In another possible implementation, an unlock interface is displayed in response to detecting the received preset touch signal is directed at the unlock application icon.

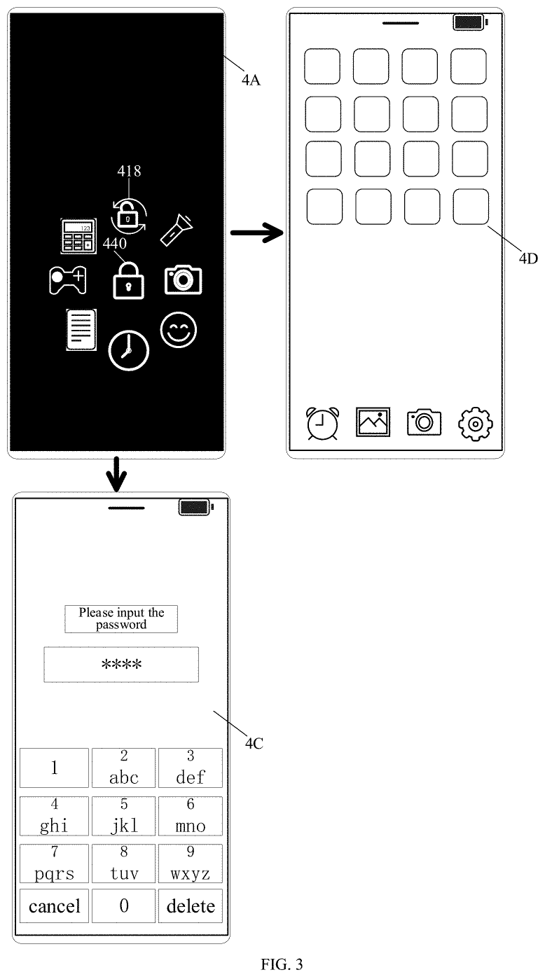

Referring to FIG. 3, FIG. 3 is a schematic diagram illustrating unlocking of the terminal device based on the embodiment illustrated in FIG. 2. In FIG. 3, the user interface will be switched from 4A to 4C to enable the user to enter a password for unlocking the terminal device, when one of the following conditions is met: a long-press operation performed by the user on the unlock application icon 418 is detected, or a pressing operation performed by the user simultaneously on both the icon 440 and the unlock application icon 418 is detected, or a dragging operation that the icon 440 is dragged by the user to partially overlap the unlock application icon 418 is detected. Alternatively, when one of the above conditions is met, the user interface is switched from 4A to 4D, that is, the user interface 4A is directly switched to the home screen 4D, which is not limited in the embodiments of the disclosure.

Based on the above, in the method for launching an application on a terminal device provided by the embodiments of the disclosure, the at least one application icon is displayed on the screen-off display interface of the terminal device, where the screen-off display interface is the user interface displayed on the terminal device in the screen-off display mode. In response to receiving the preset touch signal, the application corresponding to one application icon of the at least one application icon is launched, where the preset touch signal is triggered by the terminal device upon receiving the preset touch operation performed on the one application icon. In this way, when the screen of the terminal device is off, the terminal device is enabled to display at least one application icon on the screen-off display interface. When one of the at least one application icon is triggered by the preset touch signal, the terminal device can directly launch the application corresponding to the one triggered application icon without performing the unlock process. As such, the terminal device is enabled to directly launch the specified application on the screen-off interface without unlocking the terminal device, by which the problem that complicated operations are required to launch an application on the terminal device in the screen-off display mode can be alleviated.

Optionally, since the terminal device may launch the specified application without unlocking the terminal device, in the embodiments of the disclosure, the preset touch signal may be set as a signal not susceptible to an accident touch operation, so as to avoid the terminal device from mistakenly responding to the accident touch operation in the case where the unlocking is made unnecessary. In a possible implementation, the preset touch signal may include any one of a sliding touch signal, a long-press touch signal, and a concurrent multi-touch signal. The sliding touch signal is triggered by the terminal device upon receiving a preset sliding operation. The preset sliding operation is configured to indicate a touch operation sliding from a first position to a second position of the touch screen of the terminal device, where the first position is a preset position of the touch screen, such as the position of the icon 440, and the second position is a position where the one application icon is located. The long-press touch signal is triggered by the terminal device upon receiving a target long-press operation, and the target long-press operation is performed on the one application icon. The concurrent multi-touch signal includes signals triggered by the terminal device upon simultaneously receiving at least two target touch operations. The target touch signal includes at least a first touch signal and a second touch signal, the first touch signal is triggered upon detecting a touch operation performed on a third position of the touch screen, and the second touch signal is triggered upon detecting a touch operation performed on a fourth position of the touch screen, where the third position is the preset position of the touch screen, such as the position of the icon 440, and the fourth position is the position where the one application icon is located.

The above three optional operations in the embodiments of the disclosure, i.e., the sliding touch operation, the long-press touch operation, and the concurrent multi-point touch operation, reflect an obvious user intention. In the embodiments of the disclosure, the above three operations are used to trigger the preset touch signal, which can effectively prevent the application icons displayed on the screen-off display interface from being launched by mistake. That is, the embodiments of the disclosure can avoid the application corresponding to an application icon from being launched, when the user does not want to launch this application, or the embodiments of the disclosure can avoid a situation where the user wants to operate application icon A but the operation is made on application icon B.

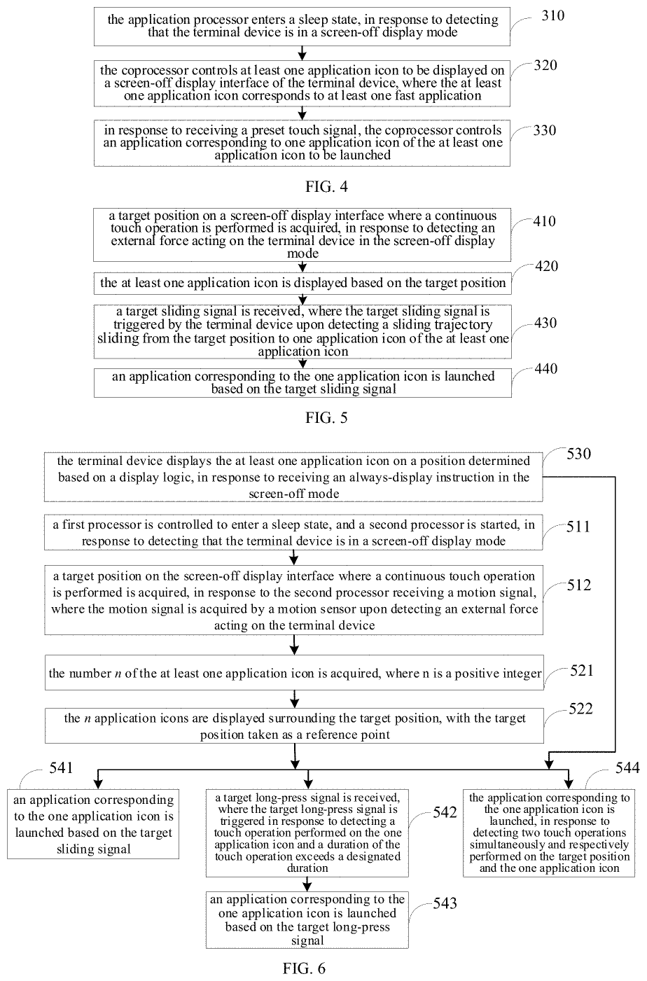

Referring to FIG. 4, a flowchart illustrating another method for launching an application on a terminal device provided by some exemplary embodiments of the disclosure is illustrated. The method for launching an application on a terminal device may be implemented by the terminal device illustrated in FIG. 1. The terminal device includes the application processor and the coprocessor. In FIG. 4, the method for launching an application on a terminal device includes blocks 310, 320 and 330.

At block 310, the application processor enters a sleep state, in response to detecting that the terminal device is in a screen-off display mode.

At block 320, the coprocessor controls at least one application icon to be displayed on a screen-off display interface of the terminal device, where the at least one application icon corresponds to at least one fast application.

In the embodiments of the disclosure, in response to detecting that the terminal device is in the screen-off display mode, the application processor is controlled to enter a sleep state, and the at least one application icon is displayed on the screen-off display interface under the control of the coprocessor. The power consumption per unit time of the coprocessor is less than the power consumption per unit time of the application processor.

Thus, in response to detecting that the terminal device is in the screen-off display mode, the application processor is controlled to enter the sleep state, and the coprocessor controls the at least one application icon to be displayed on the screen-off display interface, which can reduce the power consumption.

At block 330, in response to receiving a preset touch signal, the coprocessor controls an application corresponding to one application icon of the at least one application icon to be launched.

In the embodiments of the disclosure, in the screen-off display mode, the terminal device processes the related preset touch signal through the coprocessor. In response to receiving the preset touch signal, the application corresponding to the one application icon is launched by the coprocessor.

Based on the above, in the embodiments of the disclosure, in response to detecting that the terminal device is in the screen-off display mode, the application processor is controlled to enter the sleep state, and the coprocessor controls the at least one application icon to be displayed on the screen-off display interface of the terminal device. In response to receiving the preset touch signal, the application corresponding to the one application icon of the at least one application icon is launched under the control of the coprocessor. The preset touch signal is triggered by the terminal device upon receiving a preset touch operation performed on the one application icon. Since both the application processor and the coprocessor are provided in the terminal device, when the at least one application icon is displayed in the screen-off display mode, the application processor can be controlled to be asleep, and the coprocessor controls the displaying of the at least one application icon on the screen-off display interface, and the coprocessor launches the fast application corresponding to one application icon in response to receiving the preset touch signal. As such, not only the terminal device, being in a state that its screen is off, can be enabled to directly launch the fast application without unlocking the terminal device, but also the power consumption can be reduced.

Referring to FIG. 5, a flowchart illustrating a method for launching an application on a terminal device provided by some exemplary embodiments of the disclosure is illustrated. The method for launching an application on a terminal device may be implemented by a terminal device. In response to detecting an external force acting on the terminal device in the screen-off display mode, the terminal device may acquire a target position on the screen-off display interface where a continuous touch operation is performed. Based on the target position, the terminal device displays the at least one application icon, and receives a target sliding signal triggered by the terminal device in response to receiving an operation sliding from the target position to one application icon of the at least one application icon. The application corresponding to the one application icon is launched based on the target sliding signal. In FIG. 5, the method for launching an application on a terminal device includes blocks 410, 420, 430 and 440.

At block 410, a target position on a screen-off display interface where a continuous touch operation is performed is acquired, in response to detecting an external force acting on the terminal device in the screen-off display mode.

In the embodiments of the disclosure, the terminal device may enter the screen-off display mode in response to receiving a screen-off signal. In a possible implementation, the screen-off signal may be triggered by the terminal device in response to receiving a single click operation acting on the power button. In another possible implementation, the screen-off signal may be triggered in response to receiving a specified voice signal or receiving a specified gesture performed on the touch screen.

When the terminal device is in the screen-off display mode, the terminal device may detect whether an external force acts on it. It should be noted that, the terminal device can determine, through a corresponding sensor, whether there is an external force acting on the terminal device.

Optionally, the terminal device may detect its motion state through a motion sensor. In response to determining that the motion parameters measured by the motion sensor match a preset force movement template, the terminal device determines that there is an external force acting on the terminal device.

Optionally, the terminal device may use a pressure sensor to monitor whether there is an external force acting on the terminal device. The pressure sensor may be provided at any of the front panel, the middle frame or the rear panel, which is not limited in the disclosure.

In another possible implementation, when no external force acting on the terminal device is detected, the terminal device can continuously detect whether there is an external force acting on the terminal device.

In the embodiments of the disclosure, in response to detecting the external force acting on the terminal device, the terminal device can activate a function of detecting the touch screen of the terminal device to acquire the target position. In a possible implementation, the terminal device may control the touch screen to enter a sleep state, in the screen-off display mode. In such implementation, the terminal device no longer monitors whether the touch signal is received, which greatly reduces the power consumption of the terminal device and prevents the terminal device from mistakenly responding to an accident touch operation.

In another possible implementation, the terminal device may continuously monitor whether there is a target position on the touch screen where a continuous touch operation is performed. It should be noted that, in a possible implementation of the embodiments of the disclosure, a first processor, i.e., an application processor, and a second processor. i.e., a coprocessor, may be provided in the terminal device, and the power consumption per unit time of the first processor is larger than that of the second processor. The first processor is configured to process tasks of the terminal device in the screen-on state, i.e., the screen-on display mode in which the normal user interface can be displayed though all pixels of the terminal device, and the second processor is configured to determine, in the screen-off display mode of the terminal device, whether there is a target position of the terminal device where a continuous touch operation is performed. The provision of the second processor enables the terminal device to implement the improved method for launching an application on a terminal device and reduces the power consumption in the screen-off display mode. Optionally, in this implementation, in response to the second processor receiving a motion signal, the terminal device may use the second processor to detect whether there is a target position on the touch screen of the terminal device where the continuous touch operation is performed.

At block 420, the at least one application icon is displayed based on the target position.

In the embodiment of the disclosure, the terminal device may display the at least one application icon based on the target position.

In a possible implementation, the terminal device may display, with the target position as a center, multiple application icons surrounding the target position. The various application icons surrounding the target position are arranged in a shape of such as an arc or a circular ring.

In another possible implementation, the terminal device may take the target position as the origin of a coordinate system, and display the at least one application icon in one of the quadrants of the coordinate system. For example, the target position is taken as the origin of a coordinate system, when the target position is located at the upper left part of the touch screen, the terminal device displays the at least one application icon in the fourth quadrant; when the target position is located at the lower left part of the touch screen, the terminal device displays the at least one application icon in the first quadrant; when the target position is in the upper right part of the touch screen, the terminal device displays the at least one application icon in the third quadrant; when the target position is in the lower right part of the touch screen, the terminal device displays the at least one application icon in the second quadrant.

It should be noted that, when the user needs to display the at least one application icon on the terminal device, a long-press operation is required to be performed on the touch screen to trigger the displaying of the at least one application icon. In a possible implementation, a duration of the long-press operation may be set based on actual needs. For example, the duration may be a constant time such as 300 milliseconds, 500 milliseconds, or 1 second, which is not limited in the disclosure.

In a possible implementation, the terminal device may also display an indicator icon at the target position. For example, the indicator icon is illustrated as the icon 640, which indicates that the terminal device is locked and intuitively represents where the target position is.

At block 430, a target sliding signal is received, where the target sliding signal is triggered by the terminal device upon detecting a sliding trajectory sliding from the target position to one application icon of the at least one application icon.

In the embodiments of the disclosure, the terminal device may receive the target sliding signal. The target sliding signal is triggered by the terminal device upon detecting the sliding trajectory sliding from the target position to the one application icon.

At block 440, an application corresponding to the one application icon is launched based on the target sliding signal.

In the embodiments of the disclosure, the terminal device may constantly monitor the touch signal of the touch screen. In response to detecting the target sliding signal corresponding to an operation sliding from the target position to the one application icon, the terminal device may launch the application corresponding to the one application icon based on the target sliding signal.

In a possible implementation, when the application corresponding to the one application icon is capable of being launched without undergoing the unlock process, the terminal device may directly launch the application corresponding to the one application icon. In a possible implementation, the terminal device may be maintained in the screen-off display mode and launch the application corresponding to the one application icon in the screen-off display mode.

Based on the above, in the method for launching an application on a terminal device provided in the embodiments, the terminal device can acquire the target position on the screen-off display interface where the continuous touch operation is performed, in response to detecting the external force acting on the terminal device in the screen-off display mode. The at least one application icon is displayed based on the target position. The target sliding signal is received, where the target sliding signal is triggered by the terminal device upon detecting a sliding operation sliding from the target position to one application icon of the at least one application icon. The application corresponding to the one application icon is launched based on the target sliding signal. Therefore, when the terminal device is in the screen-off display mode, the user may press any position of the touch screen, thereby enabling the terminal device to display the at least one application icon based on the target position where the touch operation is performed. Once the user performs a sliding operation from the target position to the one application icon of the at least one application icon, the terminal device directly launches the application corresponding to the one application icon without performing the unlocking process, which reduces the possibility that the terminal device mistakenly launches an application in response to an accidental touch operation, and enables the specific application to be launched quickly.

Based on the solution disclosed in the above embodiments, the terminal device may also display the at least one application icon based on the tilt of the touch screen of the terminal device, referring to the embodiments as follows.

Referring to FIG. 6, a flowchart illustrating another method for launching an application on a terminal device provided by some exemplary embodiments of the disclosure is illustrated. The method for launching an application on a terminal device may be implemented by the terminal device illustrated in FIG. 1. In FIG. 6, the method for launching an application on a terminal device includes blocks as follows.

At block 511, a first processor is controlled to enter a sleep state, and a second processor is started, in response to detecting that the terminal device is in a screen-off display mode.

In the embodiments of the disclosure, the power consumption of the terminal device may be further reduced by providing the second processor in the terminal device. It should be noted that the first processor is configured to perform tasks when the terminal device is in the screen-on state, that is, when the touch screen is on, the terminal device adopts the first processor to execute all tasks of the terminal device. In response to detecting the touch screen is locked, the first processor enters the sleep state, and the terminal device starts the second processor to execute various tasks that required to be performed by the terminal device. It should be noted that the second processor is configured to perform the tasks of the terminal device in the screen-off display mode.

The switching between the screen-off display mode and the screen-on state of the terminal device is instantaneously completed. If the terminal device is switched from the screen-off display mode to the screen-on state, and there is still an unfinished task for the second processor, the terminal device may control the second processor to enter the sleep state only after the second processor processes the unfinished task. In addition, the first processor may be awakened to work, in response to detecting the touch screen is on.

Correspondingly, when the terminal device switches from the screen-on state to the screen-off display mode, if there is still an unfinished task for the first processor, the terminal device may control the first processor to enter the sleep state only after the first processor processes the unfinished tasks. In addition, the second processor may be awakened to work, in response to detecting the touch screen is off.

In generally, the terminal device is provided with only one processor, and the processor of the terminal device is frequently awakened to execute tasks in the screen-off display mode. The tasks in the screen-off display mode require low software resources and hardware resources, which results in a high power consumption of the terminal device, and a low screen-off display efficiency of the terminal device. In the method for launching an application on a terminal device provided in the disclosure, the terminal device adopts the second processor to execute the tasks in the screen-off display mode, and the terminal device adopts the first processor to execute the tasks in the screen-on state. As such, the efficiency of the screen-off display of the terminal device is improved, and the power consumption of the terminal device for performing the same tasks is reduced.

At block 512, a target position on the screen-off display interface where a continuous touch operation is performed is acquired, in response to the second processor receiving a motion signal, where the motion signal is acquired by a motion sensor upon detecting an external force acting on the terminal device.

In the embodiments of the disclosure, the terminal device may receive the motion signal through the second processor, and the motion signal is acquired by the motion sensor upon detecting the external force acting on the terminal device. In response to the second processor receiving the motion signal, the terminal device determines that the external force is applied to it, and at this time, the terminal device acquires the target position on the screen-off display interface where the continuous touch operation is performed.

In a possible implementation, the motion signal may be a speed signal, an acceleration signal, or an impulse, and the like. The motion sensor may be a sensor device such as an acceleration sensor, a gravity sensor, a speed sensor, or a gyroscope.

In another possible implementation, the motion sensor may also be a pressure sensor, which can directly acquire the magnitude of the external force acting on the terminal device, when the external force acting on the terminal device is detected. Optionally, the pressure sensor may be provided in the touch screen of the terminal device. In response to receiving a hard press by the user's finger against the touch screen, the magnitude of the pressure is measured and sent to the second processor.

At block 521, the number n of the at least one application icon is acquired, where n is a positive integer.

In the embodiments of the disclosure, the terminal device acquires the number n of the at least one application icon, in response to determining the target position, where n is a positive integer. The terminal device may fix the at least one application icon to be displayed. In other words, such at least one application icon is fixed, and cannot be changed by the user. Alternatively, the terminal device may provide at least one candidate application icon for selection by the user, which is not limited in the embodiments of the disclosure.

Optionally, n may be a positive integer such as 1, 2, 3, 4, . . . , 7, or 8. The terminal device may set n application icons for display by default, and may also ask the user to set the n application icons for display.

In a possible implementation, when n is set as 8, the 8 applications corresponding to the n application icons may include a calculator application, a mini game application, a memo application, a clock (including timer) application, a screen saver animation application, a camera application, a flashlight application and an unlock application. It should be noted that the screen of the terminal device is locked in the screen-off display mode. Thus, the n application icons may include a screen unlock application. When the screen unlock application is launched, the terminal device displays the unlock interface, in which the user may use at least one of a password, a graphic trajectory, a fingerprint or face recognition to unlock the screen.

At block 522, n application icons are displayed surrounding the target position, with the target position taken as a reference point.

In the embodiments of the disclosure, the terminal device may display the n application icons surrounding the target position with the target position taken as the reference point, for example, a center position of a region for displaying the n application icons.

In a possible implementation, the terminal device may display the n application icons in zonal distribution surrounding the target position, with the target position taken as the center.

In another possible implementation, if there is no enough display space for displaying the n application icons surrounding the target position with the target position as the reference point, the terminal device determines the nearest center position, which will be described in details below, as a new target position, and display the n application icons surrounding the nearest center position with the nearest center position as the reference point. For example, a preset region of the screen-off display interface may be set based on the number of the at least one application icons, and any position in the preset region is capable of serving as a center of a region for displaying the n application icons. When it is determined that the target position in a preset region of the screen-off display interface, i.e., there is enough display space for displaying the n application icons, the n application icons are displayed with the target position taken as the center. When it is determined that the target position is outside of the preset region, i.e., there is no enough display space for displaying the n application icons, one of the positions on the boundary of the preset region, which is the nearest to the target position, is determined as the center position, and the n application icons are displayed surrounding the center position.

Referring to FIG. 7, FIG. 7 is a schematic diagram illustrating an interface on which the terminal device displays n application icons provided by the embodiments illustrated in FIG. 6. In FIG. 7, when the terminal device is in the screen-off display mode, nothing is originally displayed on the touch screen 4A of the terminal device, that is, none of the pixels emits light and the touch screen presents black. When the user performs a press operation on the touch screen 4A, the terminal device first determines that there is an external force acting on the terminal device, and then determines a target position 4O of the touch screen where a continuous touch operation is performed. Subsequently, the terminal device displays 8 application icons surrounding the target position 4O. In response to detecting a sliding signal that indicates a user's touch operation sliding from the target position 4O to the camera application icon 616, the terminal device launches the camera application and displays the shooting interface 4B. Optionally, the terminal device may display an indicator icon 640 at the target position. Optionally, the terminal device may also not display the indicator icon 640.

FIG. 7 illustrates 8 application icons, which include a calculator application icon 611, a mini game application icon 612, a memo application icon 613, a clock (including timer) application icon 614, a screen saver animation application icon 615, a camera application icon 616, a flashlight application icon 617 and an unlock application icon 618.

It should be noted that the terminal device may display the at least one application icon based on the target position where the user performs the touch operation, which facilitates the user to directly slide from the target position to one of the displayed application icons, thereby improving the efficiency of launching the application.

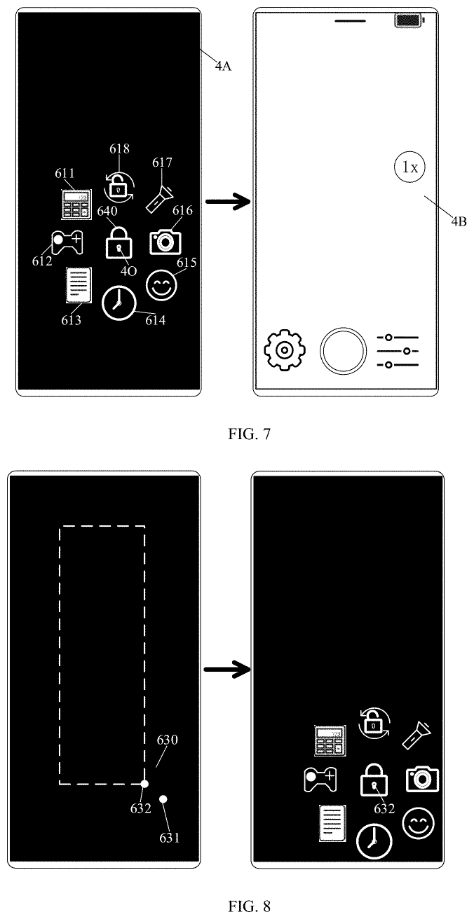

Referring to FIG. 8, FIG. 8 is a schematic diagram illustrating another interface on which the terminal device displays n application icons provided by the embodiments illustrated in FIG. 6. The preset region refers to the region inside the dashed box, and the preset region also includes the dashed box. In FIG. 8, when the terminal device is in the screen-off display mode, if a press location 631 where the user's finger presses is located in a ring shaped area 630 of the touch screen 4A that is defined by the dashed box and the border of the touch screen 4A, the terminal device determines, from the center positions which are capable of serving as the center of a region for displaying the application icons and which are located on the interior border of the ring shaped area, i.e., the dashed box, a position 632 which is the nearest to the press location 631 as the nearest center position, and display the 8 application icons surrounding the nearest center position 632 with the nearest center position 632 taken as the target position. It should be noted that, when the terminal device is in the screen-off display mode, when detecting a press acts in a position that is inside the dashed box or located exactly on the boundary of the dashed box, this position is taken as the target position.

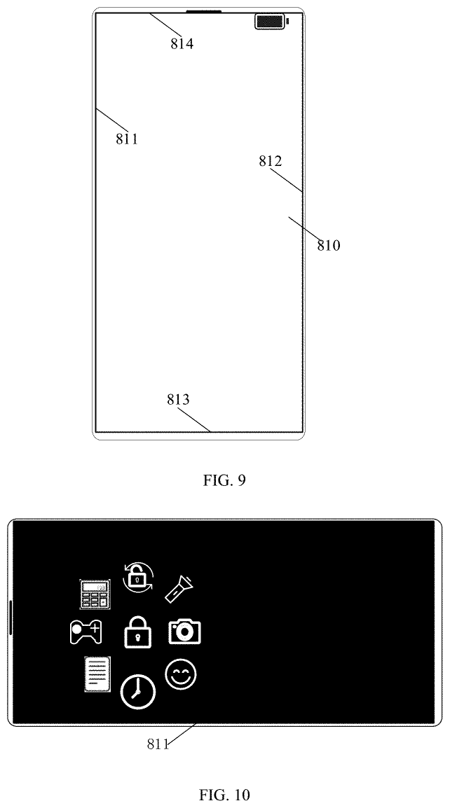

In a possible implementation, the terminal device may perform operation (a1), operation (a2), and operation (a3), to enable the terminal device to display the n application icons surrounding the target position with the target position as the reference point. In the solution in which the terminal device performs operation (a1), operation (a2), and operation (a3), the terminal device includes a gravity sensor, the touch screen is in a shape of a rectangle or a rounded rectangle, and the touch screen includes a first edge and a second edge. The first edge refers to a long edge, and the second edge refers to a short edge. For example, FIG. 9 is a schematic diagram illustrating an appearance of the terminal device provided by the embodiments illustrated in FIG. 6. In FIG. 9, the terminal device is provided with a touch screen 810 in the shape of the rounded rectangle. The touch screen 810 includes a first long edge 811, a second long edge 812, a first short edge 813 and a second short edge 814.

At operation (a1), a gravity force measured by the gravity sensor is acquired.

In the embodiments of the disclosure, the terminal device may acquire the gravity force measured by the gravity sensor. The gravity sensor may work with different measurement principles, which is not limited in the embodiments of the disclosure. The sensor component capable of measuring the gravity force may be used as the gravity sensor of the disclosure.

At operation (a2), based on a component of the gravity force on the touch screen, an edge intersecting with the component is determined as a target bottom edge. The target bottom edge is a bottom edge of the touch screen in the front viewing angle.

In the embodiments of the disclosure, the second edge or the first edge is determined as the target bottom edge, in response to detecting that the component of the gravity force on the touch screen is a zero vector; or the edge intersecting with the component of the gravity force is determined as the target bottom edge, in response to detecting that the component of the gravity force on the touch screen is a non-zero vector.

It should be noted that, the user uses the terminal device with different poses, and thus the gravity force can be projected onto the plane where the touch screen is located, so as to obtain the component of the gravity force on the touch screen. The terminal device may determine the edge of the touch screen intersecting with the component of the gravity force as the target bottom edge. Alternatively, the terminal device may determine the edge of the touch screen intersecting with the extension line of the component of the gravity force as the target bottom edge, where the extension line extends along the direction of the component of the gravity force.

In a possible implementation, when the gravity force is in a direction perpendicular to the touch screen, a default bottom edge is determined as the target bottom edge. The default bottom edge is one designated edge of the touch screen.

If the touch screen of the terminal device is in the shape of the rectangle or the rounded rectangle, the default bottom edge is the first edge or the second edge, which is not limited in the embodiments.

At operation (a3), the target bottom edge is taken as the bottom edge of the screen-off display interface, and the n application icons are displayed surrounding the target position with the target position taken as the reference point.

Referring to FIG. 10, FIG. 10 is a schematic diagram illustrating displaying of the application icons on the terminal device provided by the embodiments illustrated in FIG. 6. In FIG. 10, the component of the gravity force on the touch screen intersects with the first long edge 811. The terminal device takes the first long edge 811 as the target bottom edge to display the application icons, so that all the displayed application icons take the first long edge 811 as the target bottom edge.

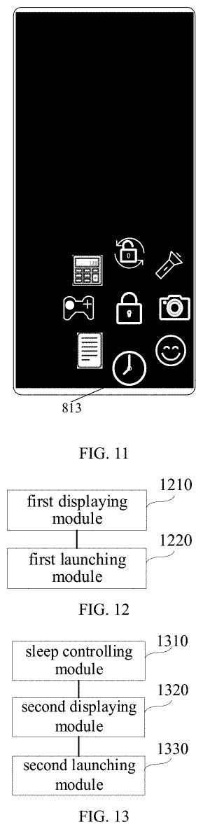

Referring to FIG. 11, FIG. 11 is another schematic diagram illustrating the displaying of the application icons on the terminal device provided by the embodiments illustrated in FIG. 6. In FIG. 11, the component of the gravity force on the touch screen intersects with the first short edge 813. The terminal device takes the first short edge 813 as the target bottom edge, to display the application icons, so that all the displayed application icons take the first short edge 813 as the target bottom edge.

It should be noted that, when the gravity force of the terminal device is in a direction perpendicular to the touch screen, the terminal device determines the default bottom edge as the target bottom edge. By taking the touch screen 810 as an example, the default bottom edge may be the first short edge 813.

In a possible implementation in which the n application icons are displayed surrounding the target position with the target position taken as the reference point, a relative position of an i-th application icon of the n application icons to the target position is constant, where i is a positive integer not greater than n.

It should be noted that there may be multiple implementations for making the relative position of the i-th application icon of the n application icons to the target position constant. In a possible implementation, a relative distance and a relative angle between the i-th application icon and the target position are both constant. In another possible implementation, the relative distance between the i-th application icon and the target position is constant. In still another possible implementation, the relative angle between the i-th application icon and the target position is constant.

It is illustrated in the following by taking a case where the relative distance and the relative angle between the i-th application icon and the target position are both constant as an example.

Referring to FIG. 7, both of the relative distance and the relative angle between the target position 4O and each of the 8 application icons are constant. In this scenario, no matter which edge of the terminal device is taken as the target bottom edge, the user may determine the position of an application icon corresponding to an application that requires to be launched, by taking the target position as the reference point. For example, if the user is aware of that the clock (including the timer) application icon 614 is directly below the target position 4O, the user may press the screen at a position, which is taken as the target position to display the application icons, and then slide down therefrom to launch the clock application regardless of the pose of the terminal device. As such, the efficiency of quickly launching the fast application by the user can be significantly improved.

In the embodiments of the disclosure, in addition to displaying the application icons on the terminal device by performing blocks 511 to 522, the terminal device may also continuously display the at least one application icon in the screen-off display mode. In this manner, the terminal device may perform block 530.

At block 530, the terminal device displays the at least one application icon on a position determined based on a display logic, in response to receiving an always-display instruction in the screen-off mode.

In the embodiments of the disclosure, the always-display instruction is configured to instruct the terminal device to continuously display the at least one application icon in the screen-off display mode.

It should be noted that, in addition to the solution of intelligently displaying the at least one application icon according to blocks 511 to 522 in the embodiments, the terminal device may also display the at least one application icon at a position corresponding to the display logic. The at least one application icon is always displayed when the terminal device is in the screen-off display mode. It should be noted that the display logic refers to a logic that continuously adjusting the display position of the at least one application icon over time. Based on such display logic, the pixels in the touch screen can work alternatively, which avoids a damage to the display screen caused by long time working.

For example, the display logic may set a period of one hour and make the period correspond to sixty different display positions. In this case, the display position of the application icon is changed to a next display position every minute. When there is one application icon to be displayed, in the period of one hour, the terminal device sets each of the sixty positions as the display position of the one application icon. When there are multiple application icons to be displayed, in the period of one hour, the terminal device may set each of the sixty positions as the target position, and display the multiple application icons surrounding the target position.

At block 541, an application corresponding to the one application icon is launched.

In the embodiments of the disclosure, the execution process of block 541 is the same as the execution process of block 240, which will not be repeated here.

At block 542, a target long-press signal is received, where the target long-press signal is triggered in response to detecting a touch operation performed on the one application icon and a duration of the touch operation exceeds a designated duration.

At block 543, an application corresponding to the one application icon is launched based on the target long-press signal.

In the embodiments of the disclosure, the terminal device may launch the application corresponding to the one application icon, in response to detecting the target long-press signal. It should be noted that, with regard to the generation of the long-press signal, in a possible implementation, the designated duration may be a constant, such as 500 milliseconds, 1 second, or 2 seconds.

At block 544, the application corresponding to the one application icon is launched, in response to detecting two touch operations simultaneously and respectively performed on the target position and the one application icon.

In the embodiments of the disclosure, the terminal device may launch the application corresponding to the one application icon, in response to detecting that the target position and the application icon are simultaneously touched.

In an implementation, when the different between a time instant at which a touch operation starts to be performed on the target position and a time instant at which a touch operation starts to be performed on the application icon is less than a preset threshold, the terminal device determines that the two touch operations are simultaneously and respectively performed on the target position and the application icon respectively.

In another implementation, if an overlap time between a duration during which a touch operation is performed on the target position and a duration during which a touch operation is performed on the application icon is larger than a target duration, the terminal device determines that the two touch operations are simultaneously and respectively performed on the target position and the application icon respectively.

Based on the above, in the embodiments, the target bottom edge of the terminal device may be determined based on the gravity force, for displaying the at least one application icon in the screen-off display mode. As such, the at least one application icon is displayed approximately based on a direction of the gravity force, and the relative distance between the displayed application icon and the target position is constant, which enables the user to quickly launch the corresponding application without viewing the touch screen, by pressing a position of the touch screen, which is determined as the target position for displaying the application icons, and then sliding therefrom to a designated position, thereby improving the efficiency of launching the application.

In the method for launching an application on a terminal device provided by the embodiments, the at least one application icon can also be continuously displayed at a respective position based on the display logic. Thus, in the disclosure, not only the at least one application icon can be continuously displayed, but also the display position can be changed over time based on the display logic, so as to prevent burn-in of the screen.

In the method for launching an application on a terminal device provided by the embodiments, the application corresponding to the one application icon is launched, in response to detecting a long-press operation performed on the one application icon, or detecting a concurrent multi-touch operation performed on both of the one application icon and the target position. As such, while improving the efficiency of launching an application, the terminal device is prevented from mistakenly launching an application through an accidental touch operation.

The apparatus embodiments will be described as follows, which may be configured to implement the method embodiments of the disclosure. Regarding details which are not described in the apparatus embodiments, reference may be made to the details of the method embodiments of the disclosure.

Referring to FIG. 12, a structural block diagram of an apparatus for launching an application on a terminal device provided by some exemplary embodiments of the disclosure is illustrated. The apparatus for launching an application on a terminal device may be implemented as an entire or a part of the terminal device by software, hardware, or a combination of thereof. The apparatus includes a first displaying module 1210 and a first launching module 1220.

The first displaying module 1210 is configured to display at least one application icon on a screen-off display interface of the terminal device, where the screen-off display interface is a user interface displayed on the terminal device in a screen-off display mode.

The first launching module 1220 is configured to launch an application corresponding to one application icon of the at least one application icon, in response to receiving a preset touch signal, where the preset touch signal is triggered by the terminal device upon receiving a preset touch operation performed on the one application icon.

In some possible embodiments, the preset touch signal related to the apparatus includes any one of the following touch signals: a sliding touch signal, a long-press touch signal, and a concurrent multi-touch signal. The sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located. The long-press touch signal is triggered by the terminal device upon receiving a target long-press operation performed on the one application icon. The concurrent multi-touch signal is triggered by the terminal device upon simultaneously receiving at least two target touch operations. Positions where the at least two target touch operations are performed includes at least a third position and a fourth position, the third position is the preset position of the touch screen, and the fourth position is the position where the one application icon is located.

Furthermore, the first launching module 1220 is configured to unlock the touch screen and display a home screen, in response to receiving a received preset touch signal directed at an unlock application icon; or display an unlock interface, in response to receiving a received preset touch signal directed at the unlock application icon.

Furthermore, when the at least one application icon is displayed on the screen-off display interface of the terminal device, the terminal device is in a screen-locked state and the at least one application icon corresponds to at least one fast application.

Furthermore, the first displaying module 1210 is configured to acquire a target position on the screen-off display interface where a continuous touch operation is performed, in response to detecting an external force acting on the terminal device in the screen-off display mode; and display, based on the target position, the at least one application icon on the screen-off display interface.

Furthermore, the first displaying module 1210 is configured to acquire the number n of the at least one application icon, where n is a positive integer; acquire a gravity force measured by the gravity sensor; determine, based on a component of the gravity force on the touch screen, an edge intersecting with the component, as a target bottom edge, where the target bottom edge is the bottom edge of the touch screen in a front viewing angle; and display the n application icons surrounding the target position based on the front viewing angle, with the target position taken as a reference point, where a relative position of an i-th application icon of the n application icons to the target position is constant, where i is a positive integer not greater than n. The terminal device includes a gravity sensor, the touch screen is in a shape of a rectangle or a rounded rectangle, and the touch screen includes a first edge and a second edge.

Furthermore, the first displaying module 1210 is configured to determine a default bottom edge as the target bottom edge, when the gravity force is in a direction perpendicular to the touch screen. The default bottom edge is one designated edge of the touch screen.

Referring to FIG. 13, a structural block diagram of another apparatus for launching an application on a terminal device provided by some exemplary embodiments of the disclosure is illustrated. The apparatus for launching an application on a terminal device may be implemented as an entire or a part of the terminal device by software, hardware, or a combination of thereof. The apparatus includes an application processor and a coprocessor, and a power consumption of the coprocessor is less than a power consumption of the application processor. The apparatus includes a sleep controlling module 1310, a second displaying module 1320 and a second launching module 1330. The sleep controlling module 1310 is configured to control the application processor to enter a sleep state, in response to detecting that the terminal device is in a screen-off display mode. The second displaying module 1320 is configured to display, under control of the coprocessor, at least one application icon on a screen-off display interface of the terminal device, where the at least one application icon corresponds to at least one fast application. The second launching module 1330 is configured to launch, under the control of the coprocessor, an application corresponding to one application icon of the at least one application icon, in response to receiving a preset touch signal. The preset touch signal is triggered by the terminal device upon receiving a preset touch operation performed on the one application icon.

In the disclosure, a terminal device is further provided. The terminal device includes an application processor and a coprocessor, and a power consumption of the coprocessor is less than a power consumption of the application processor. The application processor is configured to enter a sleep state, in response to detecting that the terminal device is in a screen-off display mode. The coprocessor is configured to display at least one application icon on a screen-off display interface of the terminal device, where the at least one application icon corresponds to at least one fast application. The coprocessor is configured to receive a preset touch signal, and in response to receiving the preset touch signal, launch an application corresponding to one application icon of the at least one application icon. The preset touch signal is triggered by the terminal device upon receiving a preset touch operation performed on the one application icon.

Optionally, the preset touch signal related to the apparatus includes any one of the following touch signals: a sliding touch signal, a long-press touch signal, or a concurrent multi-touch signal. The sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located. The long-press touch signal is triggered by the terminal device upon receiving a target long-press operation, and the target long-press operation is performed on the one application icon. The concurrent multi-touch signal is triggered by the terminal device upon simultaneously receiving at least two target touch operations. Positions where the at least two target touch operations are performed includes at least a third position and a fourth position, the third position is the preset position of the touch screen, and the fourth position is the position where the one application icon is located.

Optionally, the at least one application icon comprises an unlock application icon, and the coprocessor is configured to unlock the touch screen and display a home screen, in response to receiving a preset touch signal directed at an unlock application icon; or display an unlock interface, in response to receiving a preset touch signal directed at the unlock application icon. The at least one application icon includes the unlock application icon.

Optionally, the coprocessor is configured to acquire a target position on the screen-off display interface where a continuous touch operation is performed, in response to detecting an external force acting on the terminal device in the screen-off display mode; and display, based on the target position, the at least one application icon on the screen-off display interface.

Optionally, the terminal device includes a gravity sensor, a shape of the touch screen is a rectangle or a rounded rectangle, the touch screen includes a first edge and a second edge. When displaying at least one application icon on the screen-off display interface of the terminal device, the coprocessor is configured to: acquire the number n of the at least one application icon, where n is a positive integer; acquire a gravity force measured by the gravity sensor; determine, based on a component of the gravity force on the touch screen, an edge intersecting with the component, as a target bottom edge; and display the n application icons surrounding the target position, with the target bottom edge taken as a bottom edge of the screen-off display interface, and with the target position taken as a reference point, where a relative position of an i-th application icon of the n application icons to the target position is constant, where i is a positive integer not greater than n.

Optionally, when determining, based on a component of the gravity force on the touch screen, an edge intersecting with the component as a target bottom edge, the coprocessor is configured to: determine the second edge or the first edge as the target bottom edge, in response to detecting the component of the gravity force on the touch screen is a zero vector; or determine, as the target bottom edge, the edge intersecting with the component of the gravity force, in response to detecting that the component of the gravity force on the touch screen is a non-zero vector.

Optionally, each pixel of the terminal device is capable of being independently activated to emit light. Each pixel can be controlled by a corresponding chip to independently emit light, which enables the information displaying when the screen is off.

The embodiments of the disclosure also provide a computer-readable medium, which stores thereon at least one program instruction. The at least one instruction is loaded and executed by the processor to implement the method for launching an application on a terminal device as described in various embodiments.

It should be noted that when the apparatus for launching an application on a terminal device provided in the embodiments implements the method for launching an application on a terminal device, the division of the function modules is merely used as an example for description. In practice, the functions may be allocated to different function modules for implementation according to a requirement. In other words, an internal structure of the terminal device is divided into different function modules, so as to complete all or some of the functions described above. In addition, the apparatus and method embodiments for launching an application on a terminal device provided by the embodiments pertain to a same conception. For a specific implementation process of the apparatus, reference is made to the method embodiments. Details are not described here again.

The serial numbers of the embodiments of the disclosure are merely for description, but do not indicate the preference of the embodiments.

Those skilled in the art can understand that all or some of the operations in the above embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of this disclosure, but are not intended to limit this disclosure. Any modification, equivalent replacement, or improvement made within the spirit and principle of this disclosure shall fall within the protection scope of this disclosure.

What is claimed is:

1. A method for launching an application on a terminal device, the method comprising:
displaying at least one application icon on a screen-off display interface of the terminal device, wherein the screen-off display interface is a user interface displayed on the terminal device in a screen-off display mode; and
launching an application corresponding to one application icon of the at least one application icon, in response to receiving a preset touch signal, wherein the preset touch signal is triggered by the terminal device upon receiving a preset touch operation performed on the one application icon.

2. The method as claimed in claim 1, wherein the receiving a preset touch signal comprises one of the following:
receiving a sliding touch signal, wherein the sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located;
receiving a long-press touch signal, wherein the long-press touch signal is triggered by the terminal device upon receiving a target long-press operation performed on the one application icon; and
receiving a concurrent multi-touch signal, wherein the concurrent multi-touch signal is triggered by the terminal device upon simultaneously receiving at least two target touch operations, wherein positions where the at least two target touch operations are performed comprise at least a third position and a fourth position, the third position is the preset position of the touch screen, and the fourth position is the position where the one application icon is located.

3. The method as claimed in claim 1, wherein the at least one application icon comprises an unlock application icon, and the launching an application corresponding to one application icon of the at least one application icon, in response to receiving a preset touch signal, comprises one of the following:
unlocking the touch screen and displaying a home screen, in response to receiving a preset touch signal directed at the unlock application icon; and
displaying an unlock interface, in response to receiving a preset touch signal directed at the unlock application icon.

4. The method as claimed in claim 1, wherein at least one application corresponding to the at least one application icon comprises a fast application.

5. The method as claimed in claim 1, wherein the displaying at least one application icon on a screen-off display interface of the terminal device, comprises:
acquiring a target position on the screen-off display interface where a continuous touch operation is performed, in response to detecting an external force acting on the terminal device in the screen-off display mode; and
displaying, based on the target position, the at least one application icon on the screen-off display interface.

6. The method as claimed in claim 5, wherein the terminal device comprises a gravity sensor, the touch screen is in a shape of a rectangle or a rounded rectangle, the touch screen comprises a first edge and a second edge, and the displaying, based on the target position, the at least one application icon on the screen-off display interface, comprises:
acquiring a number n of the at least one application icon, where n is a positive integer;
acquiring a gravity force measured by the gravity sensor;
determining, based on a component of the gravity force on the touch screen, an edge of the touch screen as a target bottom edge; and
displaying the n application icons surrounding the target position, with the target bottom edge taken as a bottom edge of the screen-off display interface and with the target position taken as a reference point, wherein a relative position of an i-th application icon of the n application icons to the target position is constant, where i is a positive integer not greater than n.

7. The method as claimed in claim 6, wherein the determining, based on a component of the gravity force on the touch screen, an edge of the touch screen as a target bottom edge, comprises one of the following:
determining the second edge or the first edge as the target bottom edge, in response to detecting that the component of the gravity force on the touch screen is a zero vector; and
determining, as the target bottom edge, the edge intersecting with the component of the gravity force, in response to detecting that the component of the gravity force on the touch screen is a non-zero vector.

8. A method for launching an application on a terminal device, wherein the terminal device comprises an application processor and a coprocessor, a power consumption of the coprocessor is less than a power consumption of the application processor, and the method comprises:
controlling the application processor to enter a sleep state, in response to detecting that the terminal device is in a screen-off display mode;
displaying, under control of the coprocessor, at least one application icon on a screen-off display interface of the terminal device, wherein the at least one application icon comprises at least one of a fast application icon and an unlock application icon; and
in response to receiving a preset touch signal, launching, under the control of the coprocessor, an application corresponding to one application icon of the at least one application icon, wherein the preset touch signal is triggered by the terminal device upon receiving a preset touch operation performed on the one application icon.

9. The method as claimed in claim 8, wherein the receiving a preset touch signal, comprises one of the following:
receiving a sliding touch signal, wherein the sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located;
receiving a long-press touch signal, wherein the long-press touch signal is triggered by the terminal device upon receiving a target long-press operation performed on the one application icon; and
receiving a concurrent multi-touch signal, wherein the concurrent multi-touch signal is triggered by the terminal device upon simultaneously receiving at least two target touch operations, wherein positions where the at least two target touch operations are performed comprise at least a third position and a fourth position, the third position is the preset position of the touch screen, and the fourth position is the position where the one application icon is located.

10. The method as claimed in claim 8, wherein the displaying, under control of the coprocessor, at least one application icon on a screen-off display interface of the terminal device, comprises:
acquiring, by the coprocessor, a target position on the screen-off display interface where a continuous touch operation is performed, in response to detecting an external force acting on the terminal device in the screen-off display mode; and
displaying, under the control of the coprocessor, the at least one application icon on the screen-off display interface based on the target position.

11. A terminal device, wherein the terminal device comprises an application processor and a coprocessor, and a power consumption of the coprocessor is less than a power consumption of the application processor;
wherein the application processor is configured to enter a sleep state, in response to detecting that the terminal device is in a screen-off display mode;
wherein the coprocessor is configured to control at least one application icon to be displayed on a screen-off display interface of the terminal device, wherein the at least one application icon comprises at least one of a fast application icon and an unlock application icon; and
the coprocessor is configured to receive a preset touch signal, and in response to receiving the preset touch signal, launch an application corresponding to one application icon of the at least one application icon, wherein the preset touch signal is triggered by the terminal device upon receiving a preset touch operation performed on the one application icon.

12. The terminal device as claimed in claim 11, wherein the receiving a preset touch signal, comprises one of the following:
receiving a sliding touch signal, wherein the sliding touch signal is triggered by the terminal device upon receiving a preset sliding operation, the preset sliding operation is configured to indicate a touch operation sliding from a first position to a second position of a touch screen of the terminal device, the first position is a preset position of the touch screen, and the second position is a position where the one application icon is located;
receiving a long-press touch signal, wherein the long-press touch signal is triggered by the terminal device upon receiving a target long-press operation, and the target long-press operation is performed on the one application icon; and
receiving a concurrent multi-touch signal, wherein the concurrent multi-touch signal is triggered by the terminal device upon simultaneously receiving at least two target touch operations, wherein positions where the at least two target touch operations are performed comprise at least a third position and a fourth position, the third position is the preset position of the touch screen, and the fourth position is the one position where the application icon is located.

13. The terminal device as claimed in claim 11, wherein when the at least one application icon comprises the unlock application icon, the coprocessor is configured to perform one of the following:
unlock the touch screen and display a home screen, in response to receiving a preset touch signal directed at the unlock application icon; and
display an unlock interface, in response to receiving a received preset touch signal directed at the unlock application icon.

14. The terminal device as claimed in claim 11, wherein the coprocessor is configured to:
acquire a target position on the screen-off display interface where a continuous touch operation is performed, in response to detecting an external force acting on the terminal device in the screen-off display mode; and
display, based on the target position, the at least one application icon on the screen-off display interface.

15. The terminal device as claimed in claim 14, wherein the terminal device comprises a gravity sensor, a shape of the touch screen is a rectangle or a rounded rectangle, the touch screen comprises a first edge and a second edge, and when displaying at least one application icon on the screen-off display interface of the terminal device, the coprocessor is configured to:
acquire a number n of the at least one application icon, where n is a positive integer;
acquire a gravity force measured by the gravity sensor;
determine, based on a component of the gravity force on the touch screen, an edge of the touch screen as a target bottom edge; and
display the n application icons surrounding the target position, with the target bottom edge taken as a bottom edge of the screen-off display interface, and with the target position taken as a reference point, wherein a relative position of an i-th application icon of the n application icons to the target position is constant, where i is a positive integer not greater than n.

16. The terminal device as claimed in claim 15, when determining, based on a component of the gravity force on the touch screen, an edge of the touch screen as a target bottom edge, the coprocessor is configured to perform one of the following:
determine the second edge or the first edge as the target bottom edge, in response to detecting the component of the gravity force on the touch screen is a zero vector; and
determine, as the target bottom edge, the edge intersecting with the component of the gravity force, in response to detecting that the component of the gravity force on the touch screen is a non-zero vector.

17. The terminal device as claimed in claim 11, wherein each pixel of the terminal device is capable of being independently activated to emit light.

18. The terminal device as claimed in claim 14, wherein the coprocessor is further configured to:
display, with the target position taken as a center, the at least one application icon surrounding the target position, in response to determining that the target position is in a preset region of the screen-off display interface.

19. The terminal device as claimed in claim 18, wherein the coprocessor is further configured to:
in response to determining that the target position is outside of the preset region, determine, from positions on a boundary of the preset region, one position which is nearest to the target position, as a center position; and
display the at least one application icon surrounding the center position.

20. The terminal device as claimed in claim 11, wherein the coprocessor is further configured to:
display the at least one application icon on the screen-off display interface continuously, in response to receiving an always-display instruction by the terminal device in the screen-off display mode.
